(19) United States
(12) Patent Application Publication
(10) Pub. No.: US 2013/0077314 A1
(43) Pub. Date: Mar. 28, 2013

(54) LIGHT FIXTURES AND SEAMLESS METAL RINGS FOR LIGHT FIXTURES

(71) Applicants: Rajendra M. Patel, Troy, MI (US); Jeremy L. Reando, DeSoto, MO (US); Gerald M. Wiedemeier, Fenton, MO (US)

(72) Inventors: Rajendra M. Patel, Troy, MI (US); Jeremy L. Reando, DeSoto, MO (US); Gerald M. Wiedemeier, Fenton, MO (US)

(21) Appl. No.: 13/467,755

(22) Filed: May 9, 2012

Related U.S. Application Data
(60) Provisional application No. 61/540,294, filed on Sep. 28, 2011.

(51) Int. Cl. F21V 29/00; B32B 3/26

(52) U.S. Cl. 362/249.06; 362/249.14; 362/382; 428/596

(57) ABSTRACT

A light fixture comprising at least one light source and a metal ring formed by spinning, the at least one light source thermally coupled to an inner surface of the metal ring.

### CROSS-REFERENCE TO RELATED APPLICATION

This application claims the benefit of U.S. Provisional Application No. 61/540,294 filed Sep. 28, 2011, the entire disclosure of which is incorporated herein by reference.

### FIELD

The present disclosure relates to light fixtures and seamless metal rings for light fixtures.

### SUMMARY

This section provides a general summary of the disclosure, and is not a comprehensive disclosure of its full scope or all of its features.

According to one aspect of the present disclosure, a light fixture is disclosed. The light fixture comprises at least one light source and a metal ring formed by spinning, the at least one light source thermally coupled to an inner surface of the metal ring. The light source includes a power control circuit for the light source. The light source comprises a light emitting diode (LED). The light fixture further comprises an upper globe portion and a lower globe portion, wherein the metal ring is positioned between the upper and lower globe portions.

According to another aspect of the present disclosure, a seamless metal ring formed by spinning for a light fixture is disclosed. The seamless metal ring is configured to dissipate heat from the light fixture. The seamless metal ring comprises an inner surface and an outer surface extending about the inner surface. The inner surface includes a plurality of segmented tabs.

According to yet another aspect of the present disclosure, a light fixture is disclosed. The light fixture comprises an upper portion, a lower portion and a seamless metal ring that couples the upper portion to the lower portion of the light fixture. The seamless metal ring is formed by spinning and is configured to dissipate heat from the light fixture. The seamless metal ring comprises an inner surface and an outer surface extending about the inner surface. The inner surface includes a plurality of segmented tabs.

According to still another aspect of the present disclosure, a method of manufacturing a seamless metal ring for a light fixture is disclosed. The seamless metal ring is configured to dissipate heat from the light fixture. The seamless metal ring comprises an inner surface and an outer surface extending about the inner surface. The inner surface includes a plurality of segmented tabs. The method comprises forming the seamless metal ring from a piece of metal by a process of spinning. Additionally, the method may further comprise positioning at least one LED on each segmented tab of the plurality of segmented tabs.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a bottom plan view of a seamless metal ring for a light fixture according to one example embodiment of the present disclosure.

FIG. 2 is a bottom plan view of the seamless metal ring of FIG. 1 with a substrate coupled to the seamless metal ring.

FIG. 3A is a front view of a light fixture including a seamless metal ring according to another example embodiment of the present disclosure.

FIG. 3B is a cross sectional view of the light fixture of FIG. 3A.

FIG. 4A is a front view of another light fixture including a seamless metal ring according to yet another example embodiment of the present disclosure.

FIG. 4B is a cross sectional view of the light fixture of FIG. 4A.

FIG. 5A is a front view of still another light fixture including a seamless metal ring according to an additional example embodiment of the present disclosure.

FIG. 5B is a cross sectional view of the light fixture of FIG. 5A.

FIG. 6A is a front view of yet another light fixture including a seamless metal ring according to another example embodiment of the present disclosure.

FIG. 6B is a cross sectional view of the light fixture of FIG. 6A.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

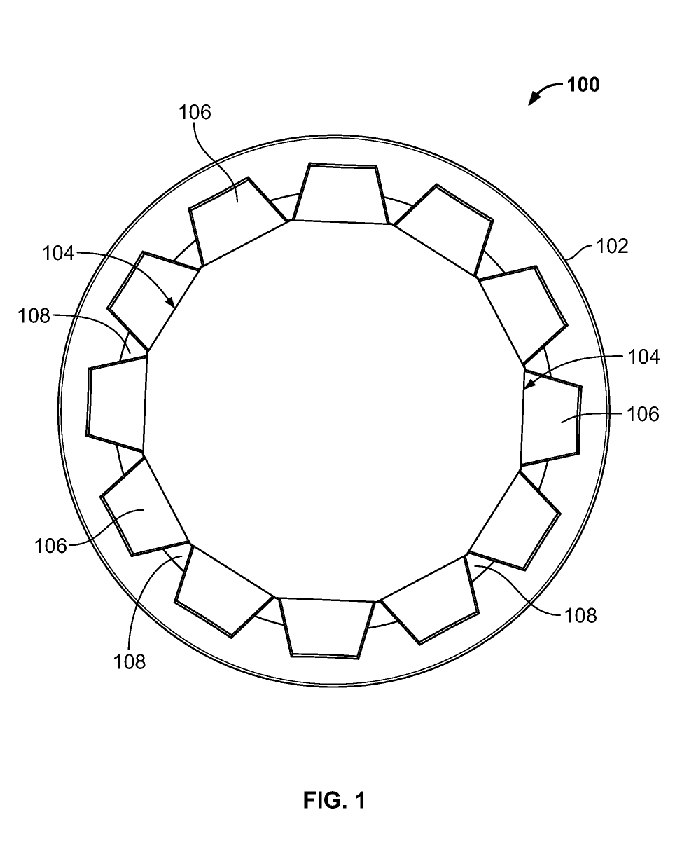

A seamless metal ring formed by spinning for a light fixture according to one example embodiment of the present disclosure is illustrated in FIG. 1 and indicated generally by reference number 100. As shown in FIG. 1, the seamless metal ring 100 includes an inner surface 104 and an outer surface 102 extending about the inner surface 104. The inner surface 104 includes a plurality of segmented tabs 106. The seamless metal ring 100 is configured to dissipate heat from the light fixture.

As shown in FIG. 1, the seamless metal ring 100 is one continuous piece. The inner surface 104 and the outer surface 102 converge at an intermediate surface 108 of the seamless metal ring 100. This configuration allows the seamless metal ring 100 the ability to dissipate heat from an interior portion of a light fixture to an exterior portion of the light fixture when the seamless metal ring 100 is attached to the light fixture. Therefore, the seamless metal ring 100 is configured to act as a heat sink. In this particular embodiment, the outer surface 102 does not include a fin or any other protrusion extending from the outer surface 102.

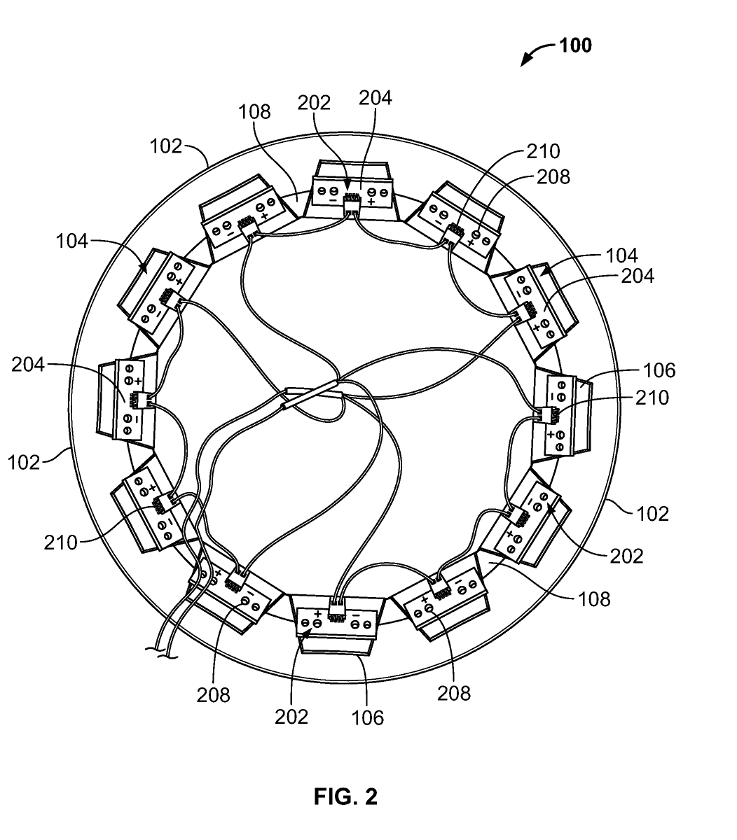

FIG. 2 illustrates the seamless metal ring 100 of FIG. 1 with a plurality of substrates 202. Each substrate 202 is coupled to a respective segmented tab 106. Each substrate 202 is coupled to an interior facing portion of the segmented tab 106. The substrate 202 may be a circuit board, a printed circuit board or any other suitable structure for coupling to each segmented tab 106. As shown in FIG. 2, each substrate 202 may include at least one light source 204. The at least one light source 204 may be thermally coupled to the inner surface 104 of the seamless metal ring 100. As shown in FIG. 2, twelve (12) light sources 204 are thermally coupled to the inner surface 104 of the seamless metal ring 100. Alternatively, the seamless metal ring 100 may include more or less light sources 204.

Each light source 204 of FIG. 2 may comprise one or more LEDs 208. As shown in FIG. 2, the light source 204 includes two (2) LEDs, thus a total of twenty-four (24) LEDs 208 are thermally coupled to the inner surface 104. Alternatively, the light source 204 may include more or less LEDs 208.

Alternatively, in further example embodiments, a fluorescent paint or any other suitable luminous paint may be used.

Further, each light source 204 may include a power control circuit 210 for the light source 204. Alternatively, each light source 204 may not include the power control circuit 210. That is, adjacent light sources may share a common power control circuit. The power control circuit 210 may be an integrated circuit or any other suitable electronic circuit. The power control circuit 210 is configured to control an operation of each LED 208.

With further reference to FIG. 1, the plurality of segmented tabs 106 of the inner surface 104 may extend in a substantially parallel plane to the outer surface 102 of the seamless metal ring 100. Alternatively, the plurality of segmented tabs 106 may as each individually be bent inward away from the outer surface 102 or outward towards the outer surface 102. Thus, the plurality of segmented tabs 106 of the inner surface 104 may extend in a nonparallel plane to the outer surface 102 of the seamless metal ring 100. Accordingly, the plurality of segmented tabs 106 may be bent to an angle to control a magnitude and direction of light emitting from the LED 108 on each projection. The angle may be any suitable angle and may depend on characteristics of a light fixture. Such characteristics may include shape, size, material, or other suitable characteristics.

The seamless metal ring 100 of FIGS. 1 and 2 may be formed by a process known as spinning. The process includes rotating a piece of metal and a mandrel (i.e., a desired finished shape) that are coupled together. The piece of metal is then formed into an axially symmetrical product by applying a force to the piece of metal. Since the axially symmetrical product is produced by using a piece of metal, a seamless product is produced. Additionally, the piece of metal may be stamped or cut prior to coupling the piece of metal to the mandrel or subsequently to forming the axially symmetrical product. This allows the piece of metal to acquire a circular opening in the axially symmetrical product (e.g., the seamless metal ring).

Additionally, using the spinning process allows for flexible design characteristics of the axially symmetrical product. Because the mandrel can be easily modified or replaced, a shape or size of the axially symmetrical product may easily be modified.

Alternatively, the seamless metal ring 100 of FIGS. 1 and 2 may be formed by any suitable method, such as stamping, casting, etc.

The seamless metal ring 100 of FIGS. 1 and 2 may include aluminum or an aluminum alloy. Alternatively, the seamless metal ring may include any suitable material known in the art. The aluminum or aluminum alloy enables the seamless metal ring to have design flexibility and lightweight characteristics. This flexibility and lightweight characteristic allow the seamless metal ring to be adaptable to fit any suitable light fixture. Accordingly, any suitable light fixture may include the seamless metal ring illustrated in FIGS. 1-2 and any of the configurations mentioned above.

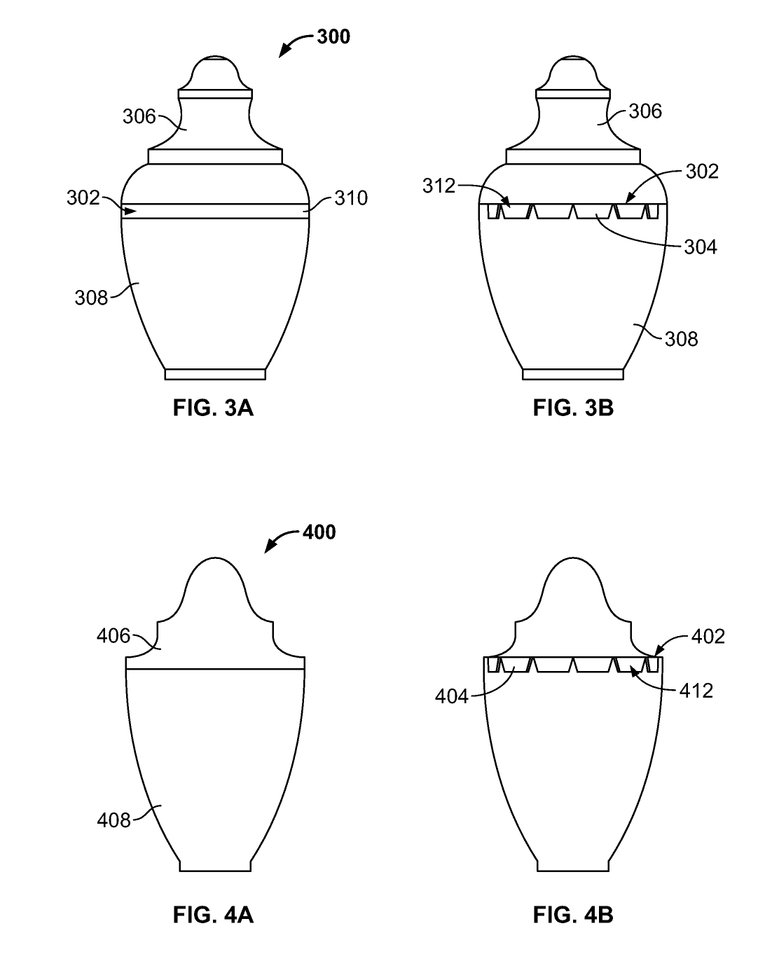

FIG. 3 illustrates a light fixture 300 according to an example embodiment of the present disclosure. As shown in FIG. 3A, the light fixture 300 includes an upper portion 306, a lower portion 308 and a seamless metal ring 302. The seamless metal ring 302 is positioned between the upper and lower portions. The seamless metal ring 302 may couple the upper portion 306 to the lower portion 308. In the same manner as described above, the seamless metal ring 300 may be formed by a process of spinning or any other suitable method, such as stamping, casting, etc., and is configured to dissipate heat from the light fixture 300. The seamless metal ring further includes an inner surface 312 and an outer surface 310 extending about the inner surface 312. The inner surface 312 includes a plurality of segmented tabs 304.

The seamless metal ring 300 may employ any of the configurations mentioned above and/or illustrated in FIGS. 1-2.

The upper portion 306 of the light fixture 300 may be plastic, metal, glass or stone and the lower portion 308 of the light fixture 300 may be plastic, metal, glass or stone. Accordingly, the upper portion 306 may or may not include the same material as the lower portion 308.

Furthermore, as described above, because the seamless metal ring 300 is lightweight and has a flexible design, it may be adaptable to fit any suitable light fixture of different sizes and shapes. Accordingly, the upper portion 306 and the lower portion 308 may be any suitable shape or size.

FIG. 4 illustrates another example embodiment of a light fixture 400. The light fixture 400 includes an upper portion 406, a lower portion 408 and a seamless metal ring 402. As shown in FIG. 4B, the seamless metal ring 402 includes an inner surface 412. The inner surface 412 includes a plurality of segmented tabs 404. As shown in FIG. 4A, the upper portion 406 extends toward lower portion 408 so to cover the seamless metal ring 402.

Although the light fixture 400 is configured differently than the light fixture 300 illustrated in FIG. 3, it may employ any of the configurations mentioned above and/or illustrated in FIG. 3. Additionally, the seamless metal ring 402 may employ any of the configurations mentioned above and/or illustrated in FIGS. 1-2.

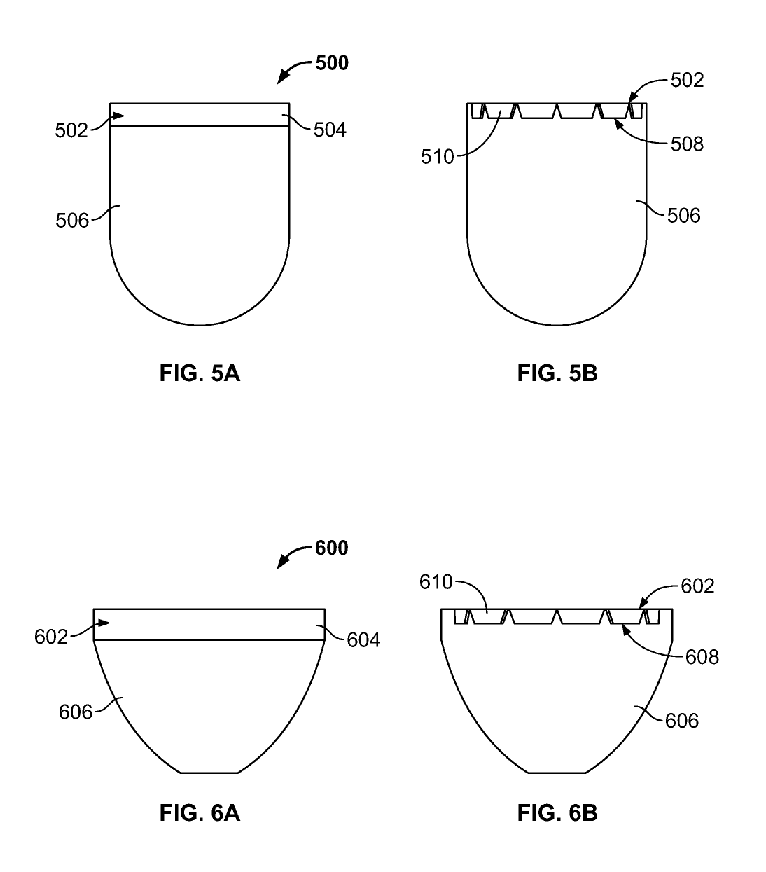

FIG. 5 illustrates yet another example embodiment of a light fixture 500 that may employ a seamless metal ring as described above. As shown in FIG. 5A, the light fixture 500 includes a lower portion 506 and a seamless metal ring 502 positioned adjacent the lower portion 506. Unlike FIGS. 3-4, the light fixture 500 of FIG. 5 does not include an upper portion. The seamless metal ring 502 includes an inner surface 508 and an outer surface 504 extending about the inner surface 508. The inner surface 508 includes a plurality of segmented tabs 510.

Although the light fixture 500 is configured differently than the light fixtures illustrated in FIGS. 3-4, it may employ any of the configurations mentioned above and/or illustrated in FIGS. 3-4. Additionally, the seamless metal ring 502 may employ any of the configurations mentioned above and/or illustrated in FIGS. 1-2.

FIG. 6 illustrates still another example embodiment of a light fixture 600 that may employ a seamless metal ring as described above. As shown in FIG. 6A, the light fixture 600 includes a lower portion 606 and a seamless metal ring 602 positioned adjacent the lower portion 606. The seamless metal ring 602 includes an inner surface 608 and an outer surface 604 extending about the inner surface 608. The inner surface 608 includes a plurality of segmented tabs 610.

Although the light fixture 600 is configured differently than the light fixtures illustrated in FIGS. 3-5, it may employ any of the configurations mentioned above and/or illustrated in FIGS. 3-5. Additionally, the seamless metal ring 602 may employ any of the configurations mentioned above and/or illustrated in FIGS. 1-2.

Light fixtures 300, 400, 500, 600 may be configured to mount to or on any suitable surface. For example, the light fixture 300 is configured to mount to a surface of a post or a pole or any other suitable surface. Additionally, light fixture 600 is configured to mount to a planar surface (e.g., a wall, a ceiling or any other suitable planar surface).

Further, the various light fixtures described herein may include one or more reflectors for reflecting light from the light source(s). The reflector(s) may be mounted to any suitable surface(s). For example, one or more reflectors may be positioned on one or more tabs, facets or other surfaces of a seamless metal ring. Alternatively, any given light fixture may be implemented without employing a reflector.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A seamless metal ring formed by spinning for a light fixture, the seamless metal ring configured to dissipate heat from the light fixture, the seamless metal ring comprising an inner surface and an outer surface extending about the inner surface; the inner surface including a plurality of segmented tabs.

2. The seamless metal ring of claim 1, wherein the seamless metal ring does not include a protrusion extending from the outer surface.

3. The seamless metal ring of claim 1, further comprising at least one LED positioned on the inner surface of the seamless metal ring, the seamless metal ring configured to dissipate heat from the at least one LED.

4. The seamless metal ring of claim 3, wherein the at least one LED is positioned on at least one segmented tab of the plurality of segmented tabs.

5. The seamless metal ring of claim 3, wherein at least two LEDs are positioned on each segmented tab of the plurality of segmented tabs.

6. The seamless metal ring of claim 1, wherein the plurality of segmented tabs extend in a substantially parallel plane to the outer surface of the seamless metal ring.

7. The seamless metal ring of claim 1, wherein the plurality of segmented tabs extend in a nonparallel plane to the outer surface of the seamless metal ring.

8. The seamless metal ring of claim 1, wherein the seamless metal ring is aluminum or an aluminum alloy.

9. A light fixture comprising the seamless metal ring of claim 1.

10. A light fixture comprising an upper portion; a lower portion; and a seamless metal ring coupling the upper portion to the lower portion of the light fixture, the seamless metal ring formed by spinning and configured to dissipate heat from the light fixture, the seamless metal ring comprising an inner surface and an outer surface extending about the inner surface; the inner surface including a plurality of segmented tabs.

11. The light fixture of claim 10, wherein the seamless metal ring does not include a protrusion extending from the outer surface.

12. The light fixture of claim 10, further comprising at least one LED positioned on at least one segmented tab of the plurality of segmented tabs, the seamless metal ring configured to dissipate heat from the at least one LED.

13. The light fixture of claim 10, wherein the plurality of segmented tabs extend in a substantially parallel plane to the outer surface of the seamless metal ring.

14. The light fixture of claim 10, wherein the plurality of segmented tabs extend in a nonparallel plane to the outer surface of the seamless metal ring.

15. The light fixture of claim 10, wherein the seamless metal ring is aluminum or an aluminum alloy.

16. The light fixture of claim 10, wherein the upper portion of the light fixture is plastic, metal, glass or stone and the lower portion of the light fixture is plastic, metal, glass or stone.

17-19. (canceled)

20. A light fixture comprising at least one light source and a metal ring formed by spinning, the at least one light source thermally coupled to an inner surface of the metal ring.

21. The light fixture of claim 20 wherein the light source includes a power control circuit for the light source.

22. The light fixture of claim 20 wherein the light source comprises a light emitting diode (LED).

23. The light fixture of claim 20 further comprising an upper globe portion and a lower globe portion, wherein the metal ring is positioned between the upper and lower globe portions.
